(19) United States
(12) Patent Application Publication
(10) Pub. No.: US 2025/0061676 A1
(43) Pub. Date: Feb. 20, 2025

(54) VALIDATION OF QUALITY OF LAYERED CLOTHING FOR AN AVATAR BODY

(71) Applicant: Roblox Corporation, San Mateo, CA (US)

(72) Inventors: Weiqi SHI, San Mateo, CA (US); Murilo Gondim COUTINHO, Houston, TX (US)

(73) Assignee: Roblox Corporation, San Mateo, CA (US)

(21) Appl. No.: 18/800,370

(22) Filed: Aug. 12, 2024

Related U.S. Application Data
(60) Provisional application No. 63/532,554, filed on Aug. 14, 2023.

(51) Int. Cl. G06T 19/20; G06T 17/20

(52) U.S. Cl. CPC G06T 19/20; G06T 17/20; G06T 2210/16; G06T 2210/21

(57) ABSTRACT

Layered clothing (LC) may be fitted on a three-dimensional (3D) avatar for a virtual experience. Some implementations relate to methods, systems, and computer-readable media to perform validation checks to check the quality (such as correctness and functionality) of the layered clothing. In some implementations, the method includes performing at least one static validation check on the clothing item to validate the clothing item when layered over an underlying surface, based on at least one property of the clothing item from the group comprising: an inner cage of the clothing item, an outer cage of the clothing item, a reference mesh of the clothing item, and combinations thereof; and in response to detecting at least one failure result from the at least one static validation check, providing an identified issue based on the at least one static validation check having the at least one failure result.

### CROSS-REFERENCE TO RELATED APPLICATIONS

This application claims priority to U.S. Provisional Application No. 63/532,554, entitled “VALIDATION OF QUALITY OF LAYERED CLOTHING FOR AN AVATAR BODY,” filed on Aug. 14, 2023, the content of which is incorporated herein in its entirety.

### TECHNICAL FIELD

This disclosure relates generally to computer graphics, and more particularly but not exclusively, relates to methods, systems, and computer readable media to provide graphical representations of layered clothing over an underlying graphical object, such as layered clothing fitted onto three-dimensional (3D) avatars in a virtual experience.

### BACKGROUND

Multi-user electronic gaming or other types of virtual experience environments may involve the use of avatars, which represent the users in the virtual experience. Three-dimensional (3D) avatars differ in geometry, shapes, and styles from one avatar to another. For example, 3D avatars may have different body shapes (e.g., tall, short, muscular, thin, etc.), may be of different types (e.g., male, female, human, animal, alien, etc.), may have any number and types of limbs, etc. Avatars may be customizable with multiple pieces of clothing and/or accessories worn by the avatar (e.g., shirt worn over the torso, jacket worn over the shirt, scarf worn over the jacket, hat worn over the head, etc.).

There are challenges with ensuring that layered clothing fits properly and behaves properly for an avatar body.

Some implementations were conceived in light of the above.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

Implementations of the present disclosure relate to providing graphical representations of layered clothing (LC) over an underlying graphical object, such as layered clothing fitted onto three-dimensional (3D) avatars in a virtual experience. When creating layered clothing, it may be helpful to validate the correctness and functionalities of user created LC and capture the problems that may arise. There may be many validation checks focusing on detecting and visualizing each specific problem. The final delivery of each validation check includes a clear description of what the issue is and how the issue can be fixed, and 3D visualizations to highlight the area that is to be fixed.

As an example, when a clothing item is layered over an underlying surface, at least one static validation check may be performed on the clothing item. Such a validation check may be based on at least one property of the clothing item related to an inner cage of the clothing item, an outer cage of the clothing item, a reference mesh of the clothing item, and combinations of these aspects of the clothing item. In response to detecting at least one failure result of the static validation check, an identified issue may be provided. It may also be possible to take automatic or manual actions to address the identified issue.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

According to one aspect, a computer-implemented method to validate a clothing item is provided, the computer-implemented method comprising: performing at least one static validation check on the clothing item to validate the clothing item when layered over an underlying surface, based on at least one property of the clothing item from the group comprising: an inner cage of the clothing item, an outer cage of the clothing item, a reference mesh of the clothing item, and combinations thereof; and in response to detecting at least one failure result from the at least one static validation check, providing an identified issue based on the at least one static validation check having the at least one failure result.

Various implementations of the computer-implemented method are described herein.

In some implementations, providing the identified issue comprises providing to a user at least one from the group comprising: a description of the identified issue, a description of a remedy for the identified issue, a visualization of an area of the clothing item affected by the identified issue, and combinations thereof.

In some implementations, the computer-implemented method further comprises automatically performing an automatic remedy for the identified issue.

In some implementations, the computer-implemented method further comprises flagging a manual remedy for the identified issue for performance by a user.

In some implementations, performing the at least one static validation check comprises performing at least one from the group comprising: an import check, a cage edit check, a user-generated content (UGC) check, and combinations thereof.

In some implementations, performing the at least one static validation check comprises identifying at least one from the group comprising: a cage UV modification, a cage and mesh intersection, a modification of an outer cage area that does not correspond to an accessory, a presence of a bloating cage, a presence of non-manifold and hole occurrences, and combinations thereof.

In some implementations, identifying the cage UV modification comprises: creating a spatial hash map for a UV map of the inner cage of the clothing item based on values for vertices of the UV map of the inner cage of the clothing item; and detecting collisions of the UV map of the outer cage of the clothing item with corresponding vertices of the UV map of the inner cage of the clothing item based on the spatial hash map.

In some implementations, identifying the cage and mesh intersection comprises finding correspondences between vertices in the inner cage of the clothing item and vertices of the outer cage of the clothing item; and performing raycasting between the corresponding vertices to identify intersecting vertices that indicate the cage and mesh intersection.

In some implementations, identifying the modification of the outer cage area that does not correspond to an accessory comprises: finding correspondences between vertices in the inner cage of the clothing item and vertices in the outer cage of the clothing item; and analyzing line segments that connect the corresponding vertices.

In some implementations, identifying the presence of the bloating cage comprises: measuring cage mesh distances as distances between vertices of the reference mesh of the clothing item and corresponding vertices of the outer cage of the clothing item; and building a Gaussian distribution based on the cage mesh distances, wherein if the cage mesh distances for predetermined vertices exceed a predetermined number of standard deviations of the Gaussian distribution, the predetermined vertices are identified as part of the bloating cage.

In some implementations, identifying the presence of the non-manifold and hole occurrences comprises detecting the non-manifold and hole occurrences using edge loops using half angle and half edge information in at least one from the group comprising: the inner cage of the clothing item, the outer cage of the clothing item, and combinations thereof.

In some implementations, the computer-implemented method further comprising categorizing respective static validation checks of the at least one static validation check as one of an error, a warning, a visual quality suggestion check, or a user-generated content (UGC) check.

In some implementations, in response to at least one result of the at least one static validation check indicating that the clothing item satisfies a threshold number of static validation checks of the at least one static validation check, importing the clothing item into the virtual experience, wherein after the importing, the clothing item is available to be worn by an avatar that participates in the virtual experience.

According to another aspect, a non-transitory computer-readable medium is provided. The non-transitory computer-readable medium with instructions stored thereon that, responsive to execution by a processing device, causes the processing device to perform operations comprising: performing at least one static validation check on a clothing item to validate the clothing item when layered over an underlying surface, based on at least one property of the clothing item from the group comprising: an inner cage of the clothing item, an outer cage of the clothing item, a reference mesh of the clothing item, and combinations thereof; and in response to detecting at least one failure result from the at least one static validation check, providing an identified issue based on the at least one static validation check having the at least one failure result.

Various implementations of the non-transitory computer-readable medium are described herein.

In some implementations, providing the identified issue comprises providing to a user at least one from the group comprising: a description of the identified issue, a description of a remedy for the identified issue, a visualization of an area of the clothing item affected by the identified issue, and combinations thereof.

In some implementations, performing the at least one static validation check comprises performing at least one from the group comprising: an import check, a cage edit check, a user-generated content (UGC) check, and combinations thereof.

In some implementations, performing the at least one static validation check comprises identifying at least one from the group comprising: a cage UV modification, a cage and mesh intersection, a modification of an outer cage area that does not correspond to an accessory, a presence of a bloating cage, a presence of non-manifold and hole occurrences, and combinations thereof.

According to another aspect, a system is disclosed, comprising: a memory with instructions stored thereon; and a processing device, coupled to the memory, the processing device configured to access the memory, wherein the instructions when executed by the processing device cause the processing device to perform operations comprising: performing at least one static validation check on a clothing item to validate the clothing item when layered over an underlying surface, based on at least one property of the clothing item from the group comprising: an inner cage of the clothing item, an outer cage of the clothing item, a reference mesh of the clothing item, and combinations thereof; and in response to detecting at least one failure result from the at least one static validation check, providing an identified issue based on the at least one static validation check having the at least one failure result.

Various implementations of the system are described herein.

In some implementations, performing the at least one static validation check comprises performing at least one from the group comprising: an import check, a cage edit check, a user-generated content (UGC) check, and combinations thereof.

In some implementations, performing the at least one static validation check comprises identifying at least one from the group comprising: a cage UV modification, a cage and mesh intersection, a modification of an outer cage area that does not correspond to an accessory, a presence of a bloating cage, a presence of non-manifold and hole occurrences, and combinations thereof.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF THE DRAWINGS

FIG. 1 is a diagram of an example system architecture that includes a 3D environment platform that can support validation checking for layered clothing, in accordance with some implementations.

FIG. 2 illustrates an example body cage, in accordance with some implementations.

FIG. 3 illustrates another example body cage, in accordance with some implementations.

FIG. 4 illustrates an example of portions of a body cage that are grouped into corresponding body parts, in accordance with some implementations.

FIG. 5 illustrates an example of a clothing layer deformed over a body cage, in accordance with some implementations.

FIG. 6 illustrates an example of an outer cage formed based on the clothing layer and portions of the body cage of FIG. 5, in accordance with some implementations.

FIG. 7 is a diagram illustrating examples of a mesh and cage, in accordance with some implementations.

FIG. 8 is a flowchart illustrating a method of an importer layered clothing (LC) validation flow, in accordance with some implementations.

FIG. 9 is a flowchart illustrating a method of static validation flow, in accordance with some implementations.

FIG. 10 is a table illustrating example validation categories, in accordance with some implementations.

FIG. 11 is a flowchart illustrating a method of performing validation checks, in accordance with some implementations.

FIG. 12 is a flowchart illustrating a method of performing specific validation checks, in accordance with some implementations.

FIG. 13 is a flowchart illustrating a method including details of performing specific validation checks, in accordance with some implementations.

FIG. 14 is a diagram illustrating an interface to manage validation checks, in accordance with some implementations.

FIG. 15 is another diagram illustrating an interface to manage validation checks, in accordance with some implementations.

FIG. 16 is yet another diagram illustrating an interface to manage validation checks, in accordance with some implementations.

FIG. 17 is a flowchart illustrating a method including details of performing specific validation checks, in accordance with some implementations.

FIG. 18 is a block diagram illustrating an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “one implementation,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

The present disclosure is directed towards, inter alia, techniques to provide assistance to developers, artists, and other users/entities in the generation of layered clothing for three-dimensional (3D) avatars that may be used in a virtual experience (e.g., a 3D environment). To achieve this, various implementations provide tools and techniques (e.g., algorithms) to validate the quality (e.g., correctness and functionality) of user-created layered clothing on a 3D virtual environment platform and identifies the problems/issues that may be present with the layered clothing.

While artists author assets in a digital content creation (DCC) program, it may be difficult to perform effective validation of such assets. The techniques provide a way to validate assets and facilitate correcting and/or managing validation issues in such assets.

The technical solution provided herein includes that various static validation checks are applied to an asset at import time. These validation checks may help identify potential issues with respect to the asset (e.g., errors, warnings, visual quality suggestions, user-generated content (UGC) requirements).

Once the potential issues are identified, they may be provided on a user interface (UI) of a client device of a user. The UI may permit the user to interactively select issues. Some issues may be resolvable automatically, while others may require a manual fix.

The technical benefits may include making it considerably easier to identify potential issues with assets by automating validation checks and providing an effective user interface to manage such validation checks. Moreover, the identification of the potential issues may occur at import time. It may also be easier to resolve the potential issues, because it may be possible to interactively select issues to resolve and facilitate resolution of such issues after validation checks identify, organize, and visualize such issues for resolution.

According to various implementations, validation checks may be performed to detect and visualize each specific problem that may be encountered with respect to avatars. The delivery/output of each validation check may include a description of the issue and a remedy for the issue and may also include 3D visualizations that highlight the area(s) that is to be remedied/fixed.

The techniques described herein to validate the quality of layered clothing may be applied to three-dimensional (3D) avatars that are used in a virtual experience. Such virtual experiences are sometimes described herein in the context of an electronic game. It is understood that such implementations described in the context of electronic games are for purposes of convenience in providing examples and illustrations.

The techniques described herein can be used for other types of virtual experiences in a three-dimensional (3D) environment that may not necessarily involve an electronic game having one or more players represented by avatars. Examples of virtual experiences may include a virtual reality (VR) conference, a 3D session (e.g., an online lecture or other type of presentation involving 3D avatars), an augmented reality (AR) session, or in other types of 3D environments in which one or more users are represented in the 3D environment by one or more 3D avatars.

With layered clothing, an automated cage-to-cage fitting technique may be used for 3D avatars. The technique permits any body geometry to be fitted with any clothing geometry, including enabling layers of clothing to be fitted over underlying layer(s) of clothing, thereby providing customization without the limits imposed by pre-defined geometries, or requiring complex computations to make a clothing item compatible with arbitrary body shapes of avatars or other clothing items.

The cage-to-cage fitting is also performed algorithmically (i.e., using specified techniques) by a gaming platform or gaming software (or other virtual experience platform/software that operates to provide a 3D environment), without requiring avatar creators (also referred to as avatar body creators, or body creators) or clothing item creators to perform complex computations. The terms “clothing” or “piece of clothing” or other analogous terminology used herein are understood to include graphical representations of clothing and accessories, and any other item that can be placed on an avatar in relation to specific parts of an avatar cage.

At runtime during a game or other virtual experience session, a player/user accesses a body library to select a particular avatar body and accesses a clothing library to select pieces of clothing to place on the selected avatar body. A 3D environment platform that presents avatars implements the cage-to-cage fitting techniques to adjust (by suitable deformations, determined automatically) the piece of clothing to conform to the shape of the body, thereby automatically fitting the piece of clothing onto the selected avatar body (and any intermediate layers, if worn by the avatar).

When the piece of clothing is fitted over the avatar body and/or underlying piece of clothing, the techniques described herein may be performed to deform or otherwise fit the piece of clothing more precisely to the avatar, such as in terms of scale (e.g., proportionality), shape, etc. The user can further select an additional piece of clothing to fit over an underlying piece of clothing, with the additional piece of clothing being deformed to match the geometry of the underlying piece of clothing.

The implementations described herein are based on the concept of “cages” and “meshes.” A body “mesh” (or “render mesh”) is the actual visible geometry of an avatar. A body “mesh” includes graphical representations of body parts such as arms, legs, torso, head parts, etc. and can be of arbitrary shape, size, and geometric topology. Analogously, a clothing “mesh” (or “render mesh”) can be any arbitrary mesh that graphically represents a piece of clothing, such as a shirt, pants, hat, shoes, etc. or parts thereof.

In comparison, a “cage” represents an envelope of features points around the avatar body that is simpler than the body mesh and has weak correspondence to the corresponding vertices of the body mesh. As is explained in further detail later below, a cage may also be used to represent a set of feature points on a piece of clothing.

With regards to quality validation for layered clothing, a quality checker tool and/or other related tool(s) and supporting components/functionality of some implementations may be implemented in a library or other repository that can be accessed and used during different stages of asset creation. For example, the quality checker may be used in different stages of creating an avatar, piece of clothing, accessory, or other graphical object.

In some implementations, the quality checker tool may be available in a studio or other configuration environment where a user can create, edit, test, etc. graphical objects. The quality checker tool of some implementations may also be used at an importer stage (e.g., 3D mesh importer), used at a publishing stage (e.g., user generated content (UGC) validation), integrated with an accessory fitting tool or other tool(s), etc.

According to various implementations, the quality checker may perform validation checks on an inner cage, outer cage, and reference mesh. For example, in the case of the avatar body, the inner cage represents a default “mannequin” (and different mannequins may be provided for different avatar body shapes) and the “outer cage” of the avatar body represents the envelope around the shape of the avatar body. A plurality of validation checks may be available in the library. Examples of some of such validation checks are described below.

In some implementations, the validation checks may be static validation checks. Static validation checks refers to that the cages and meshes are validated before deformation and hidden surface removal (HSR) is applied. In some implementations, dynamic validation checks may be performed additionally or alternatively to static validation checks.

Static validation checks may be enabled for users at import time in some implementations. Static validation checks for early identification of layered clothing (LC)-related issues may be provided with several types of information. The information may include a description of what the issue is and how the issue can be fixed. The information may also include 3D visualizations to highlight the area that is to be fixed. The information may also include automated fixes for issues, if possible.

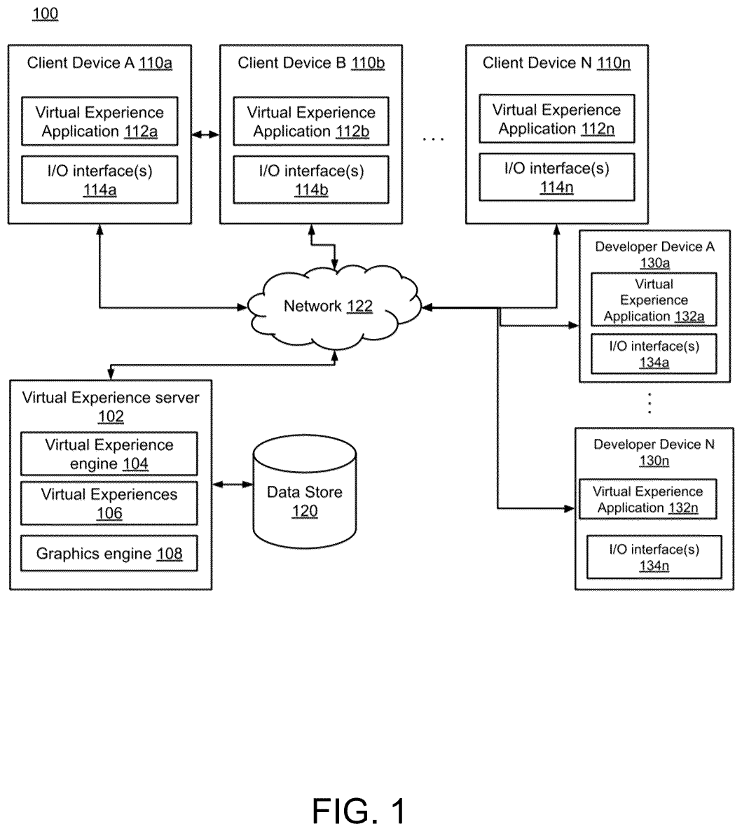

### FIG. 1—System Architecture

FIG. 1 is a diagram of an example system architecture that includes a 3D environment platform that can support validation checking for layered clothing, in accordance with some implementations. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client devices(s) 110 and developer device(s) 130 may refer to the same or same type of device.

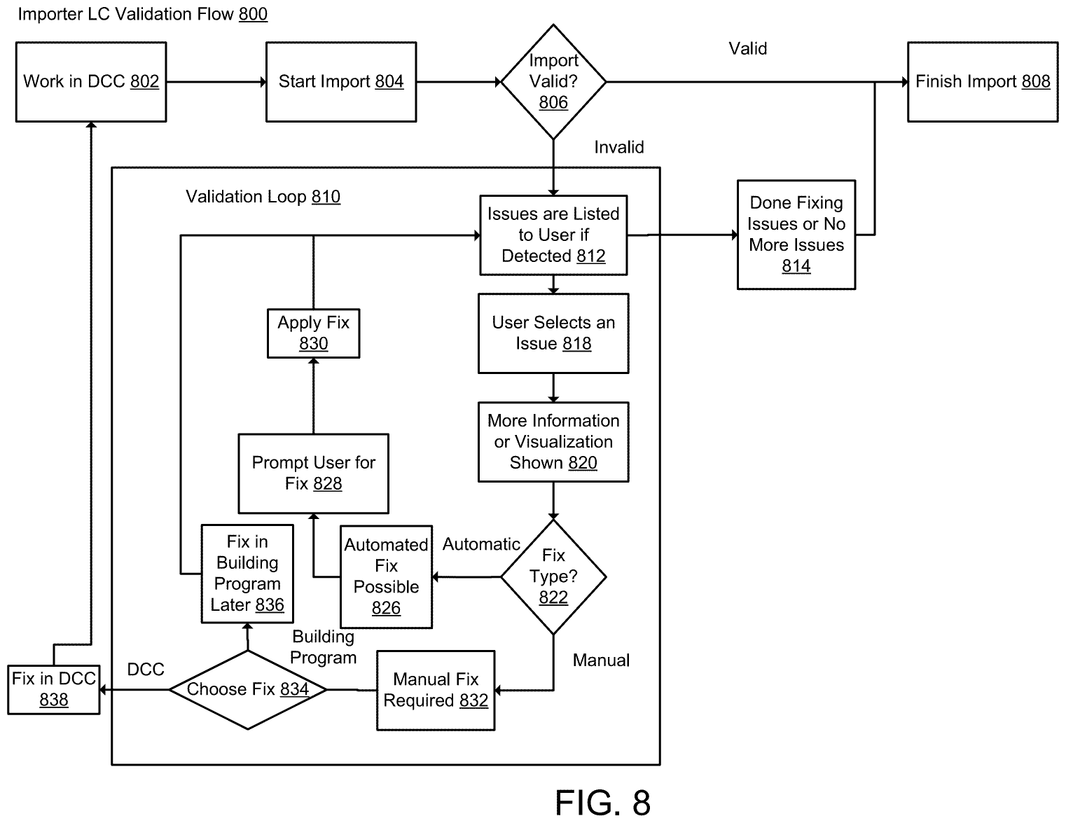

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 and/or virtual experience engine 104 may perform one or more of the operations described below in connection with the flowcharts shown in FIGS. 8-9, 11-13 and 17. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may also include multiple storage components (e.g., multiple drives or multiple databases) that may also span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N: N synchronous and/or asynchronous text-based communication). A record of some or all user communications may be stored in data store 120 or within virtual experiences 106. The data store 120 may be utilized to store chat transcripts (text, audio, images, etc.) exchanged between participants, with appropriate permissions from the players and in compliance with applicable regulations.

In some implementations, the chat transcripts are generated via virtual experience application 112 and/or virtual experience application 132 or and are stored in data store 120. The chat transcripts may include the chat content and associated metadata, e.g., text content of chat with each message having a corresponding sender and recipient(s); message formatting (e.g., bold, italics, loud, etc.); message timestamps; relative locations of participant avatar(s) within a virtual experience environment, accessories utilized by virtual experience participants, etc. In some implementations, the chat transcripts may include multilingual content, and messages in different languages from different sessions of a virtual experience may be stored in data store 120.

In some implementations, chat transcripts may be stored in the form of conversations between participants based on the timestamps. In some implementations, the chat transcripts may be stored based on the originator of the message(s).

In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 102 may be a virtual gaming server. For example, the gaming server may provide single-player or multiplayer games to a community of users that may access as “system” herein) includes online virtual experience server 102, data store 120, client or interact with virtual experiences using client devices 110 via network 122. In some implementations, virtual experiences (including virtual realms or worlds, virtual games, other computer-simulated environments) may be two-dimensional (2D) virtual experiences, three-dimensional (3D) virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments” or “virtual environments” herein) where multiple environments may be linked. An example of an environment may be a three-dimensional (3D) environment. The one or more environments of a virtual experience 106 may be collectively referred to as a “world” or “virtual experience world” or “gaming world” or “virtual world” or “universe” herein. An example of a world may be a 3D world of a virtual experience 106. For example, a user may build a virtual environment that is linked to another virtual environment created by another user. A character of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters, decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experiences 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine/application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 exceeds a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For instance, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a user's character within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc.

One or more characters (also referred to as an “avatar” or “model” herein) may be associated with a user where the user may control the character to facilitate a user's interaction with the virtual experience 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types, e.g., shirts, pants, etc. the online virtual experience platform may provide users access to simplified 3D virtual object models that are represented by a mesh of a low polygon count, e.g., between about 20 and about 30 polygons.

In some implementations, the user may also control the scale (e.g., height, width, or depth) of a character or the scale of components of a character. In some implementations, the user may control the proportions of a character (e.g., blocky, anatomical, etc.). It may be noted that is some implementations, a character may not include a character virtual experience object (e.g., body parts, etc.) but the user may control the character (without the character virtual experience object) to facilitate the user's interaction with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's character for view or use by other users of the online virtual experience server 102. In some implementations, creating, modifying, or customizing characters, other virtual experience objects, virtual experiences 106, or virtual experience environments may be performed by a user using a I/O interface (e.g., developer interface) and with or without scripting (or with or without an application programming interface (API)). It may be noted that for purposes of illustration, characters are described as having a humanoid form. It may further be noted that characters may have any form such as a vehicle, animal, inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character (e.g., avatar) can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to client device 110 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application may be an online virtual experience server application for users to build, create, edit, upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to developer device 130 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application 132 may be an online virtual experience server application for users to build, create, edit, upload content to the online virtual experience server 102 as well as interact with online virtual experience server 102 (e.g., provide and/or engage in virtual experiences 106 hosted by online virtual experience server 102). As such, the virtual experience application may be provided to the developer device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a virtual experience developer may obtain access to virtual experience virtual objects, such as in-platform currency (e.g., virtual currency), avatars, special powers, accessories, that are owned by or associated with other users.

In general, functions described in one implementation as being performed by the online virtual experience server 102 can also be performed by the client device(s) 110, or a server, in other implementations if appropriate. In addition, the functionality attributed to a particular component can be performed by different or multiple components operating together. The online virtual experience server 102 can also be accessed as a service provided to other systems or devices through suitable application programming interfaces (APIs), and thus is not limited to use in websites.

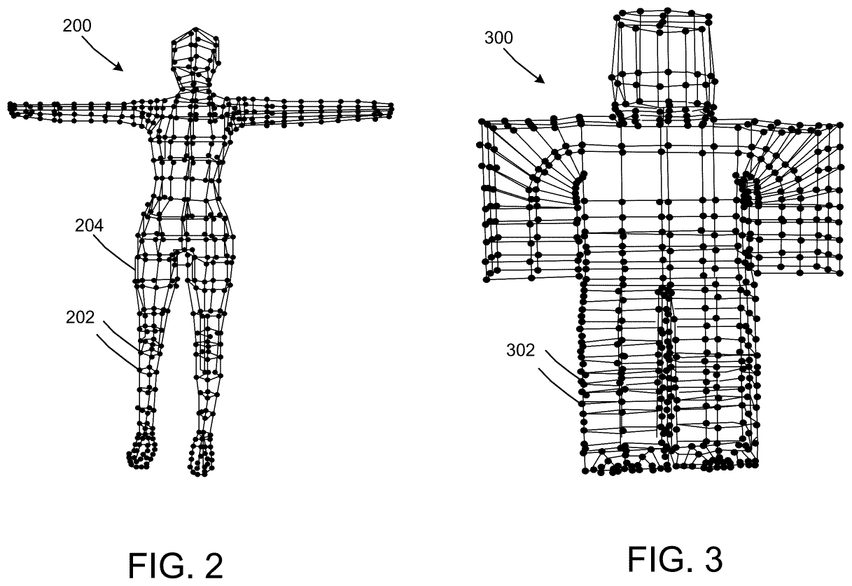

### FIG. 2—Example Body Cage

FIG. 2 illustrates an example body cage 200, in accordance with some implementations. The body cage 200 is an outer cage that envelopes or is superimposed on the external surface/contours of a humanoid body shape that acts as a mannequin. The underlying humanoid body shape (mannequin, not shown), which is enveloped by the body cage 200, may be represented by or comprised of a body mesh that includes multiple polygons and their vertices. The polygons of the body mesh (as well as those of a clothing mesh) may be triangles, with the surface area of each triangle providing a “face” or “mesh face.”

The body cage 200 comprises a plurality of feature points 202 that define or otherwise identify or correspond to the shape of the mannequin. In some implementations, the feature points 202 are formed by the vertices of segments/sides 204 of multiple polygons (or other geometric shape) on the mannequin. According to various implementations, the polygons may be triangles, with the surface area of each triangle providing a “face” or “cage face” (not illustrated in FIG. 2). In some implementations, the feature points 202 may be discrete points, without necessarily being formed by vertices of any polygons.

The body cage 200 of FIG. 2 provides an example of a low-resolution body cage with 642 feature points (or some other number of feature points; this is merely a particular example) for a humanoid body geometry that lacks fingers. Other examples may use a body cage with 475 feature points (or some other number of feature points; this is merely a particular example). A body cage of a humanoid geometry that includes fingers may have 1164 feature points (or some other number of feature points; this is merely a particular example), for example. Higher resolution body cages may include 2716 feature points (or some other number of feature points; this is merely a particular example). These numbers (and ranges thereof) of feature points are just some examples. The number of feature points may vary from one implementation to another depending on factors such as preferred resolution, processing capability of the 3D platform, user preferences, size/shape of the mannequin, etc.

### FIG. 3—Example Body Cage

FIG. 3 illustrates another example body cage 300, in accordance with some implementations. Cages may be provided for any arbitrary avatar body shape or clothing shape. The body cage 300 is an outer cage that envelopes or is superimposed on the external surface/contours of a body mesh of a generic gaming avatar body shape.

Compared to the body cage 200 of FIG. 2, the body cage 300 of FIG. 3 may have the same number of feature points. In some implementations, the body cage 300 may have a different number of feature points compared to the body cage 200, such as a fewer or greater number of feature points 302 as a consequence of a different (simpler or more complex) geometric shape of the gaming avatar and/or based on other factor(s). Thus, the number of feature points from one body cage to another may be selected as appropriate for different body shapes or other body properties.

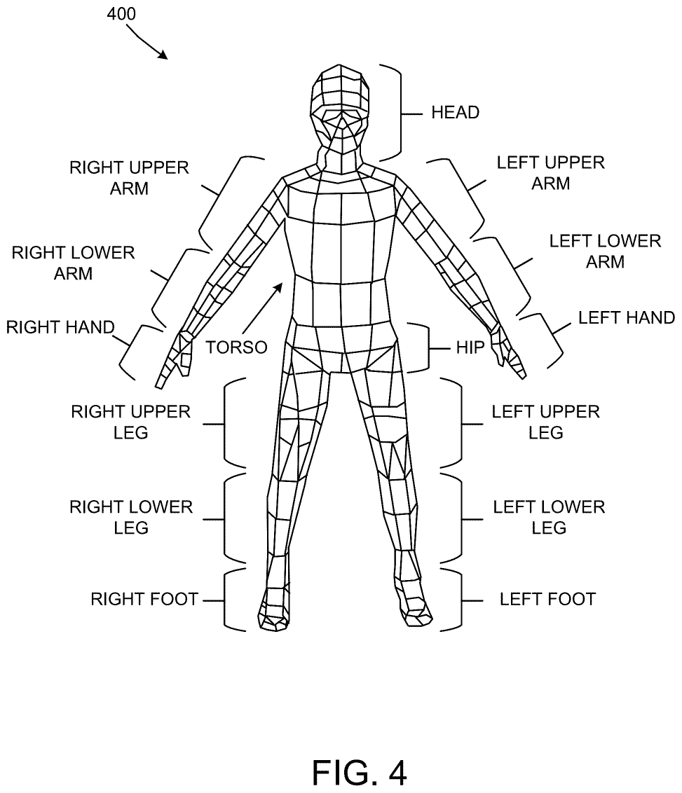

### FIG. 4—Portions of Body Cage

FIG. 4 illustrates an example of portions of a body cage 400 that are grouped into corresponding body parts, in accordance with some implementations.

In some implementations, for bandwidth and performance/efficiency purposes or other reason(s), the number of feature points of a cage may be reduced to a smaller number than those provided above. Furthermore, in some implementations, the feature points (vertices) in a body cage may be arranged into a plurality of groups (e.g., 15 groups) that each represent a portion of the body shape.

More particularly, the 15 body parts illustrated in FIG. 4 are (for a humanoid mannequin): head, torso, hip, right foot, left foot, left lower leg, right lower leg, left upper leg, right upper leg, left hand, right hand, left lower arm, right lower arm, left upper arm, and right upper arm. The number of parts in any body shape may be greater or fewer than the 15 body parts illustrated. For example, a “one-armed” avatar character may have 12 (as opposed to 15) body parts, due to the omission of a hand, lower arm, and upper arm. Furthermore, other body shapes may involve a fewer or greater numbers of body parts, depending on factors such as body geometry, preferred resolution, processing capability, type of avatar character (e.g., animal, alien, monster, and so forth), etc.

Each of the 15 groups/parts in example FIG. 4 includes the feature points that define that part of the avatar body. Such group(s) of feature points may in turn be mapped to a corresponding piece of clothing. For example, the feature points in the body cage 400 that define the left/right lower arms, the left/right upper arms, and the torso may be used as an outer cage to be mapped with an inner cage of a jacket, such that a graphical representation of jacket is made up of graphical meshes that render left/right arms and a torso of the jacket that logically and correspondingly fit over left/right arms and a torso of an avatar body.

Moreover, this separation into multiple groups (such as illustrated in FIG. 4) enables customized fitting of a piece of clothing over uncommon body shapes. For instance, a 3D avatar may be in the form of a “one-armed” avatar character that is missing the left arm. Thus, the body cage for that 3D avatar lacks the groups of feature points corresponding to the left hand, left lower arm, and left upper arm. When a jacket is subsequently selected to be fit over that 3D avatar, the right lower arm, right upper arm, and torso of the jacket may be deformed to fit over the corresponding right lower arm, right upper arm, and torso of the 3D avatar (body mannequin), and the left lower arm and the left upper arm of the jacket are not deformed (e.g., remains rigid in its original form from its parent space) since there is no left arm cage in the body mannequin to deform against.

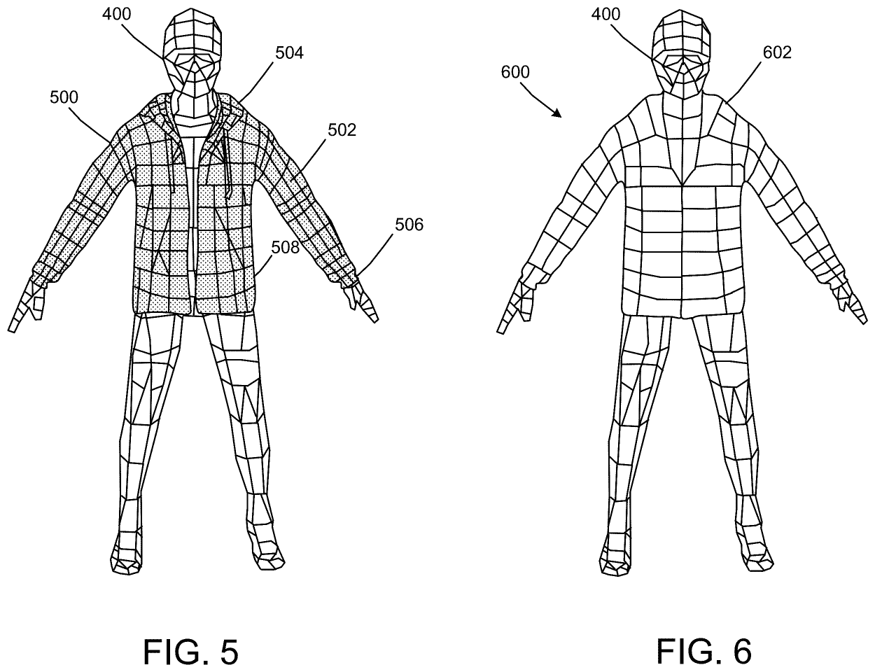

### FIG. 5—Clothing Layer Deformed Over Body Cage

FIG. 5 illustrates an example of a clothing layer 500 deformed over a body cage (such as the body cage 400 illustrated in FIG. 4), in accordance with some implementations. The clothing layer 500 is a graphical representation of a jacket (illustrated in gray shading in FIG. 5) having parts that may be generated/rendered using a polygon mesh 502 (e.g., a clothing mesh) that comprises collection of vertices, edges, and faces (which may be triangle faces or other polygon faces).

The clothing layer 500 includes an inner cage (not illustrated in FIG. 5) having feature points that correspond to the feature points of the body cage 400. Specifically, the feature points of the inner cage of the clothing layer 500 are mapped to the feature points of the body cage 400 that make up the left and right lower arms, the left and right upper arms, and the torso.

In some implementations, this mapping includes mapping the feature points of the inner cage of the clothing layer 500 directly onto the coordinate locations of the corresponding feature points of the arms and torso of the body cage 400. Such mapping may involve a 1:1 correspondence when the inner cage and outer cage have same number of feature points, and the mapping may be n:1 or 1:n (wherein n is an integer greater than 1), in which case multiple feature points in one cage may be mapped to the same feature point of the other cage (or some feature points may be unmapped).

The clothing layer 500 further includes an outer cage having feature points that are spaced apart from and linked to the corresponding feature points of its inner cage of the clothing layer 500. The feature points of the outer cage of the clothing layer 500 define or are otherwise located along the external surface contours/geometry of the jacket, to define features such as a hood 504, cuffs 506, straight-cut torso 508, etc. of the jacket.

According to various implementations, the spatial distances (e.g., a spatial distance between a feature point of the inner cage of the clothing layer 500 and a corresponding feature point of the outer cage of the clothing layer 500) are kept constant during the course of fitting the clothing layer 500 over an outer cage of an existing layer (or avatar body). In this manner, the feature points of the inner cage of the clothing layer 500 may be mapped to the feature points of the body cage 400, to “fit” the inside of the jacket over the avatar's torso and arms.

The distances between the feature points of the inner cage of the clothing layer 500 and the corresponding feature points of the outer cage of the clothing layer 500 being kept constant, the outer contours of the jacket may also be deformed so as to match the shape of the avatar body, thereby resulting in at least partial preservation of the visual appearance (graphical representation) of the hood, cuffs, straight-cut torso and other surface features of the jacket while at the same time matching the shape of the avatar body as illustrated in FIG. 5. In this manner, the clothing layer 500 may be deformed in any appropriate manner to fit any arbitrary shape/size of an avatar body (body cage), such as tall, short, slim, muscular, humanoid, animal, alien, etc.

### FIG. 6—Example Outer Cage

FIG. 6 illustrates an example of the clothing layer and portions of the body cage 400 of FIG. 5 being used to form an outer cage 600, in accordance with some implementations. In some implementations, additional clothing layers over other clothing layer(s) may be placed (e.g., in response to user selection).

More specifically, the feature points of the outer cage of the clothing layer 500 of FIG. 5 are now combined with the feature points of the body cage 400, so as to result in a composite outer cage 600 that is made up of feature points of exposed portions of the body cage 400 and feature points along the exterior surface of the jacket.

For example, the exposed outer surfaces 602 of the jacket (formed by the body, hood, and sleeves of the jacket) provide a set of feature points and the exposed legs, hands, head, and part of the chest of the body that are not covered by the jacket provide another set of feature points, and these two sets of feature points (combined) provide the feature points of the outer cage 600.

The feature points of the outer cage 600 in example FIG. 6, which correspond to and define the outer surface/shape of the jacket, may be the same feature points of the outer cage of the clothing layer 500 of FIG. 5. In some implementations, different and/or additional and/or fewer feature points may be used for the region of the jacket in the outer cage 600 in FIG. 6, as compared to the feature points for the outer cage of the jacket (clothing layer 500) of FIG. 5.

For instance, additional feature points may be computed for the outer cage 600 encompassed by the jacket area (as compared to the outer cage of the clothing layer 500 of FIG. 5), if higher resolution or more precise fitting is preferred for the next layer of clothing above the outer cage 600. Analogously, feature points may be computed for the outer cage 600 encompassed by the jacket area (as compared to the outer cage of the clothing layer 500), if a lower resolution or less precise fitting is preferred for the next layer of clothing above the outer cage 600 and/or due to other considerations such as processing/bandwidth efficiency improvements provided by using fewer feature points when possible.

In operation, if the user provides input to fit an additional clothing layer (such as an overcoat or other article of clothing) over the jacket (clothing layer 500) and/or over other parts of the avatar body, then the feature points of the inner cage of such additional clothing layer are mapped to the corresponding feature points of the outer cage 600. Deformation may thus be performed in a manner similar to that described with respect to FIG. 5. According to some implementations, radial basis function (RBF) techniques and/or other analogous interpolation techniques may be used to deform a piece of clothing that is fitted over an underlying piece of clothing or body part of an avatar.

Thus, in accordance with the examples of FIGS. 5 and 6 with respect to layering clothing, a first layer of clothing (clothing layer 500) is wrapped around the body by matching the feature points of the “outer cage” (body cage 400) of the avatar body with the feature points of the “inner cage” of the first layer of clothing. This matching may be done in the UV space (where UV refers to a coordinate system) of the cages, so as not to have to rely on the number of feature points matching exactly between the inner and outer cages.

For example, the feature points may be vertices with both position and texture space coordinates. Texture space coordinates are usually expressed in a range [0,1] each for U and V coordinates. The texture space may be thought of as an “unwrapped” normalized coordinate space for the vertices. By performing the correspondence of the two sets of vertices in the UV space and not using their positions, vertex-to-vertex correspondence may be performed in the normalized space there by removing the hard obligation of exact vertex to vertex index mapping.

As discussed, in the techniques to layer clothing, each avatar body and clothing item is thus associated A with an “inner cage” and an “outer cage.” In the case of the avatar body, the inner cage represents a default “mannequin” (and different mannequins may be provided for different avatar body shapes) and the “outer cage” of the avatar body represents the envelope around the shape of the avatar body.

For the clothing items, the “inner cage” represents the inner envelope that is used to define how the clothing item wraps around an underlying body (or around a body with prior clothing layers already fitted on it), and the “outer cage” represents the way that the next layer of clothing is wrapped around this particular clothing item when worn on the avatar body.

According to various implementations, the various cages described herein may be invisible during runtime. For example, while participating in a virtual experience, including traversing an avatar through a virtual 3D environment of a virtual experience, placing clothing onto an avatar body, wearing the clothing, animating the avatar, etc., the vertices and segments of the cage(s) may not be visible to the user and other users/viewers of the 3D environment.

Also, the avatar and its deformed clothing are presented during runtime so as to appear “cage-less,” such that only the visual meshes of deformed clothing, skins, avatar body parts, etc. are visible to the user(s)—in reality, one or more cages may be present on the avatar for purposes described herein to deform clothing, to envelope avatar body parts and clothing items, to change an avatar body, etc., but not visible to the user(s) during runtime. The cages may be made visible to a user (e.g., such as via a view/edit cages command, during a configuration phase, etc.), so that the user can view and manipulate the cages if necessary to change an avatar body as described herein, to create a cage, or to accomplish other purposes.

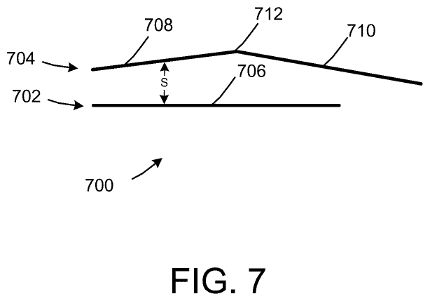

### FIG. 7—Example Mesh and Cage

FIG. 7 is a diagram 700 illustrating examples of a mesh 702 and cage 704, in accordance with some implementations. More specifically, the diagram 700 represents a side view of the cage 704 that overlies/envelopes the mesh 702.

The mesh 702 may be a body mesh (e.g., graphically showing a portion of the avatar's body, such as a hand, arm, etc.) or may be a clothing mesh (e.g., graphically showing a portion of a piece of clothing, such as a sleeve, hood, etc.). The mesh 702 may include a mesh face 706 formed by the outwardly facing surface of a polygon (e.g., a triangle). The mesh 702 may include a plurality of polygons and their corresponding mesh faces, with the polygons connected to each other at their segment sides and vertices.

Analogously, the cage 704 may include a plurality of polygons (e.g., triangles) and their corresponding cage faces, such as previously illustrated and described above. The diagram 700 of FIG. 7 illustrates two cage faces 708 and 710 formed by outwardly facing surfaces of respective polygons of the cage 704. These polygons may be joined to each other at 712, which may be a segment or vertex.

The cage faces 706, 708, 710, and/or other faces or portions thereof of meshes or cages may be hidden or potentially hidden as additional clothing pieces are layered over the mesh 702 and cage 704. Also as illustrated in the diagram 700 of FIG. 7 and as previously explained above, the cage 704 overlies/envelopes the mesh 702. According to various implementations, there may be a distance S (e.g., a distance in terms of pixels, in a normal/perpendicular direction relative to the surface of the mesh 702) between the mesh 702 and the cage 704, when the cage 704 is generated and placed over the mesh 702.

The distance S may vary over different regions of the mesh 702 and the cage 704. For example, the distance S may be substantially zero at some regions where the cage 704 touches the mesh 702, and the distance S may be greater than zero at other regions where there is a spatial separation between the mesh 702 and the cage 704.

Moreover, the diagram 700 illustrates that the single mesh face 706 is enveloped by two cage faces 708 and 710. This is merely an example. There may be a one-to-one overlap of cage faces to mesh faces at some regions, a one-to-many overlap of cage faces to mesh faces at some regions, a many-to-one overlap of cage faces to mesh faces at some regions, etc.

Furthermore, the edges of the mesh faces and cage faces may not necessarily align with each other. For instance, in the diagram 700 of FIG. 7, the left edge of the cage face 708 is substantially aligned with the left edge of the mesh face 706. In comparison, the right edge of the cage face 710 extends past or is otherwise not aligned with the right edge of the mesh face 706.

According to various implementations and as illustrated and described above with respect to FIGS. 2-6, a cage is enveloped over a body mesh and/or over a clothing mesh (e.g., a piece or layer of clothing), and so such a cage becomes an outer cage that conforms to the shape and contours of the underlying surface.

A next layer of clothing may be provided with inner and outer cages, such that deformation of this next layer of clothing is achieved by mapping, matching, or otherwise associating the points of the inner cage of this next layer of clothing to the corresponding points of the outer cage of the underlying body or layer of clothing. In some implementations, the outer cage itself of the underlying body or layer of clothing is or becomes the inner cage of the next layer of clothing.

For the inner and outer cages of a particular piece/layer of clothing, the points of these inner and outer cages may be mapped to each other. When the points of the inner cage of this particular layer are associated/positioned with respect to the points of the outer cage of the underlying layer, deformation of the particular layer of clothing occurs when the points of its outer cage track/follow the displacement of the points of its inner cage.

### FIG. 8—Importer Layered Clothing Validation Flow

FIG. 8 is a flowchart illustrating a method 800 of an importer layered clothing (LC) validation flow, in accordance with some implementations. The operations/states/components in the method 800 may include the following as examples.

At block 802, the user is working in a digital content creation (DCC) program. Block 802 may be followed by block 804. At block 804, an import process is started. Block 804 may be followed by block 806. At block 806, a validation check is performed to ascertain if the import is valid or not. If the check indicates that the import is valid, block 806 is followed by block 808. If the check indicates that the import is invalid, block 806 is followed by block 812, as a first aspect of block 810 (the validation loop).

At block 808, importing is finished. For example, at block 808, it may have been determined at block 806 that the importing is valid, and hence no issues occurred that may cause a requirement to enter the validation loop at block 810. As noted, if at block 806, it is determined that the importing is invalid, block 806 is followed by entry into validation loop at block 810.

At block 810, a validation loop is illustrated (containing a way to loop through issues and work with the user to resolve them). The validation loop begins at block 812. At block 812, issues may be listed to the user, if detected. Such issues may have been identified when it was established that the import was not valid (such as at block 806). For example, in block 812, the issues may be categorized based on type, such as by severity (e.g., error, warning, visual quality suggestion, user-generated content (UGC) requirement, etc.).

If an issue to be fixed is detected, block 812 may be followed by block 818. However, it may be determined at block 812 that either there are no remaining issues, there are no remaining issues that are possible to fix, or there are no remaining issues that the user wants to fix. In these cases, block 812 is followed by block 814. At block 814, it is confirmed that there are no more issues to be fixed by method 800, so block 814 may be followed by block 808, to finish the importation process.

If the user wants to fix issue(s), at block 818, an issue is selected by a user. Block 818 may be followed by block 820. At block 820, more information or visualization illustrated. For example, at block 820, more information or visualization may include providing to a user at least one from a list comprising a description of the identified issue, a description of a remedy for the identified issue, a visualization of an area of the clothing item affected by the identified issue, and combinations thereof. However, block 820 may be optional, and after a user selects an issue at block 818, block 818 may be followed by block 822 to determine how to fix the issue i.e., either manually or automatically.

Block 822 may be followed by block 826 or block 832. Block 822 is followed by block 826 if an automated fix is possible. Block 822 may be followed by block 832 if a manual fix is appropriate.

At block 826, an automated fix is possible. Block 826 may be followed by block 828. At block 828, a user is prompted to authorize the automatic fix. Block 828 may be followed by block 830, if the user chooses to authorize the automatic fix. However, block 828 is optional. Block 826 may be followed directly by block 830, and the automatic fix may be applied automatically (i.e., without user intervention).

At block 830, a fix is applied. Specifically, block 830 pertains to an automatic fix. Once the automatic fix is approved or if the issue occurs in an environment in which the given issue simply proceeds automatically with the fix, in block 830 the appropriate automatic fix is applied, resolving the issue. Block 830 may be followed by block 812, to list issues to a user again (if they are detected). Accordingly, at block 812, it is possible to resolve other issues or end the validation loop at block 810 if a user is done fixing issues at block 814 (such that the importing is finished at block 808).

At block 832, a manual fix is appropriate. Block 832 may be followed by block 834. At block 834, it is chosen whether to perform the manual fix in a building program later or to fix in a digital content creation (DCC) program. If the choice is to fix in the building program later, block 834 is followed by block 836. If the choice is to fix in the DCC, block 834 is followed by block 838. At block 836, the issue is flagged to be fixed in a building program later (and validation loop at block 810 can continue).

Block 836 may then be followed by block 812, continuing in validation loop at block 810 to manage detection of validation issues. At block 838, a fix in a DCC program may be chosen. In this situation, block 838 is followed by block 802, so the fix may be performed in block 802 (in the DCC program) and the import may be started again at block 804. If the import is now valid at block 806, the importation can be finished at block 808. Otherwise, the validation loop at block 810 occurs once more.

Thus, FIG. 8 illustrates, overall, an importation process where an asset is imported and validated. If there are problems with the asset, a validation loop occurs in which, through interaction with a user, issues may be shared with a user. The user can use this list of issues to get more information about the issues and resolve the issues (automatically or manually). The validation loop occurs until the issues are fixed or the user decides not to fix any other issues.

The import flow shown in FIG. 8 may not be the only area/stage to utilize static validation checks. In various implementations, static validation checks may be utilized within an engine (e.g., a virtual experience engine), since there may be other stages of a layered clothing creation pipeline where static validation checks may be beneficial.

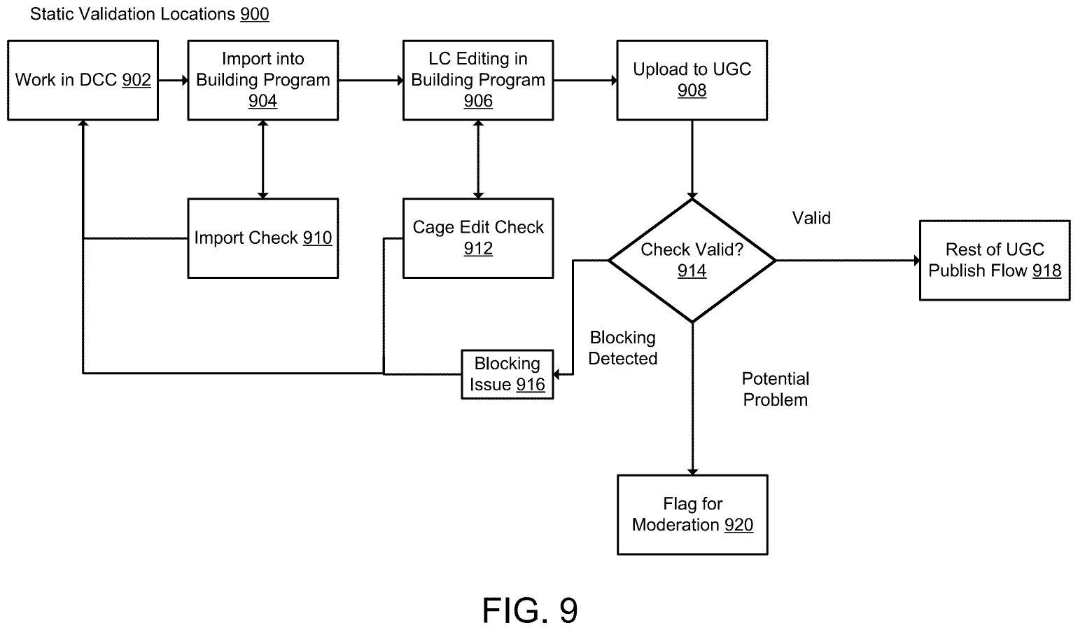

### FIG. 9—Static Validation Flow

FIG. 9 is a flowchart illustrating a method 900 of static validation flow, in accordance with some implementations. FIG. 9 illustrates example static validation checking locations, with particular locations of types of static validation checking in a validation flow illustrated, in accordance with some implementations. The validation checks, states in the validation flow, and other information in FIG. 9 may include the following as examples. Method 900 may begin at block 902.

At block 902, the user is working in a digital content creation program (DCC). For example, the user may design an asset (such as a piece of clothing) in the DCC program. Block 902 may be followed by block 904. At block 904, an importing into a building program occurs. As the importing of block 904 occurs, an import check 910 occurs, or these may happen in sequence. If the import check 910 detects a problem, the method 900 may return to block 902 to permit a user to fix import issues in a DCC program. After successfully passing through block 904, block 904 may be followed by block 906.

In block 906, layered clothing (LC) editing may occur in a building program. While the LC editing of block 906 occurs, a cage edit check 912 occurs, or these may happen in sequence. If the cage edit check 912 detects a problem, the method 900 may return to block 902 to permit a user to fix cage edit issues in a DCC program. After successfully passing through block 906, block 906 may be followed by block 908.

In block 908, an upload to a user-generated content (UGC) repository may occur. Block 908 may be followed by block 914. At block 914, a UGC requirement check may be performed to see if there is a blocking issue, another UGC-related potential program, or if the UGC requirement check indicates that the upload (and the earlier stages) are valid. If a blocking issue is detected, block 914 may be followed by block 916. At block 916, the blocking issue is detected, and block 916 may be followed by block 902 to return to the DCC at block 902 to resolve the issue.

If another potential problem is detected, block 914 may be followed by block 920. At block 920, the potential problem may be flagged for moderation. However, if the checks are successful, and at block 914, the checks are deemed valid, block 914 may be followed by block 918. At block 918, the rest of the UGC publication flow occurs.

Thus, FIG. 9 illustrates a somewhat different presentation of how the static validations occur. When a user works in a DCC program, the user can then try to import into a building program, followed by LC editing in the building program, followed by an upload to a UGC program. At each of these states, a check (e.g., an import check, a cage edit check, or a UGC requirement check) confirms that the asset is ready for the next stage or may cause a return to the DCC program to resolve the issues. Following these checks, if there is still a potential problem, the potential problem may be flagged for moderation. Otherwise, the rest of the UGC publication flow may continue.

Some implementations seek to provide as many validation checks to the user as possible in order to best guide the user. However, doing this may result in many of the issues having varying levels of impact and relevance to different users. To best deliver applicable information, some implementations categorize the validation checks into certain types.

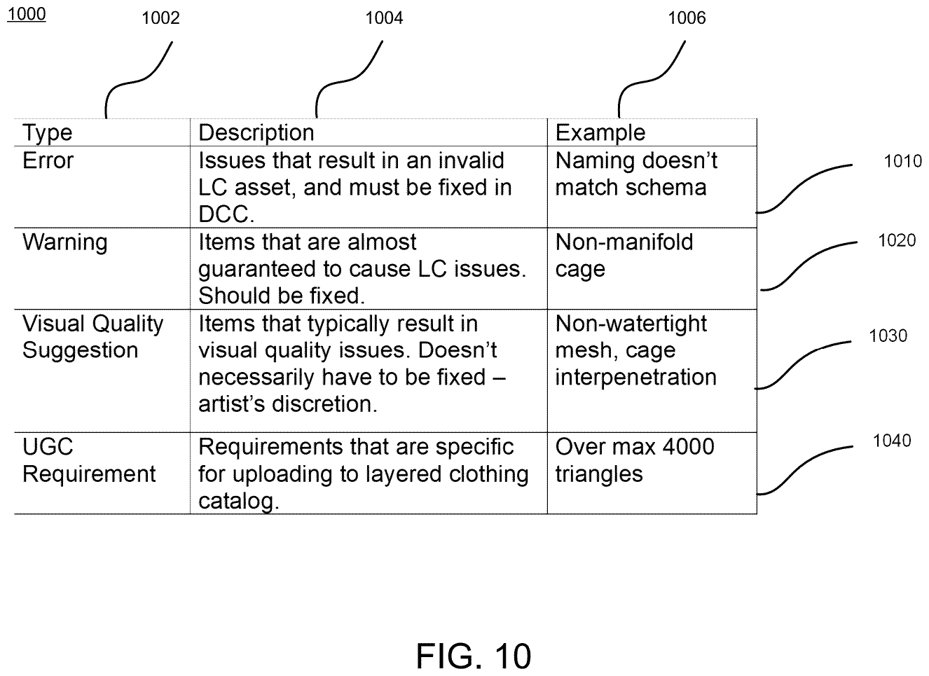

### FIG. 10—Example Validation Categories

FIG. 10 is a table 1000 illustrating example validation categories, in accordance with some implementations. Table 1000 illustrates several types of validation categories, including information related to the type of validation categories, the description of a given validation category, and an example of the validation category.

Table 1000 may have three columns. For example, table 1000 may have a type column 1002, a description column 1004, and an example column 1006. The type column 1002 specifies a category of issue, where different issues may be of different severity. The description column 1004 provides a more detailed explanation of what a given category of issue means. Example column 1006 provides one or more examples of particular issues that may correspond to a given type of issue and the applicable description.

For example, row 1010 illustrates a validation category for errors (in type column 1002). This validation category is described (in description column 1004) as issues that result in an invalid layered clothing (LC) asset and are to be fixed in a digital content creation (DCC). An example of an error (in example column 1006) is where naming does not match a corresponding schema. Unless errors are resolved, the asset does not work.

For example, row 1020 illustrates a validation category for warnings (in type column 1002). Warnings are described (in description column 1004) as items that are almost guaranteed to cause LC issues. It is thus important that such issues be fixed. An example of a warning (in example column 1006) is a non-manifold cage. Unless warnings are resolved, it is unlikely that that an asset works.

For example, row 1030 illustrates a validation category for visual quality suggestions (in type column 1002). Visual quality suggestions are described (in description column 1004) as items that usually result in visual quality issues. Such issues do not necessarily have to be fixed, and a fix may be done at the discretion of the artist. An example of a visual quality suggestion (in example column 1006) is a non-watertight mesh, or cage interpenetration.

For example, row 1040 illustrates a validation category for UGC requirement (in type column 1002). UGC requirement are described (in description column 1004) as items that are specific for uploading to a layered clothing catalog. An example UGC requirement (in example column 1006) are an issue where there are more than a maximum of 4000 triangles. Such requirements are only necessary if the asset is to be uploaded to a catalog.

There may be other validation categories not set forth herein. In some implementations, a subset of these validation categories may be used.

There may be a variety of more specific validation checks. Such validation checks may also have varying priorities. For example, a priority 1 issue may include an error of modified UVs, which may have an automated fix. A priority 2 issue may include a warning of a naming not matching a schema, which may have an automated fix. A priority 3 issue may include a warning of an outer cage's average distance to a clothing mesh being too large, which may have a manual fix.

A priority 4 issue may include a warning of an outer cage having outer points with a large distance to a rendering mesh, which may have a manual fix. A priority 5 issue may include a warning of an outer cage area that does not correspond to how an accessory has been modified (e.g., a torso cage modified for a shoe), which may have a manual fix. A priority 6 issue may include a warning of a deleted cage geometry, which may have a manual fix.

A priority 7 issue may include a warning of an outer cage being inside a clothing mesh, which may have a manual fix. A priority 8 issue may include a warning of a non-manifold cage, which may have a manual fix (such as in a digital content creation program (DCC)). A priority 9 issue may include a warning of determining that cage vertices have nearly coincident positions, which may have an automatic fix.

A priority 10 issue may include a suggestion of detecting that a clothing mesh is not watertight, which may have a manual fix (such as in a digital content creation program (DCC)). A priority 11 issue may include a suggestion of an inner cage intersecting with a Layered Clothing (LC) mesh, which may have a manual fix (such as in a digital content creation program (DCC) or another creation program). A priority 12 issue may include a suggestion of an outer cage intersecting with a LC mesh, which may have a manual fix (such as in a digital content creation program (DCC) or another creation program).

A priority 13 issue may include a warning of one or more vertices influenced by more than four bones. an outer cage's average distance to a clothing mesh being too large, which may have a manual fix. A priority 14 issue may include a warning of an outer cage intersecting or being inside an inner cage, which may have a manual fix.

The above issues are associated with certain priorities, issue types, and fix types. However, it may be recognized that not every issue may be checked for and/or fixed. In some implementations, more, fewer, or different issues may be considered, detected, and/or fixed.

There may also be several UGC-specific validation checks. These may be a requirement that there be a maximum of 4000 triangles, which may be an import check. These may be a requirement that there be a maximum texture size of 1024 by 1024 pixels, which may be an import check. There may be a requirement that it is not appropriate to use certain kinds of vertex color values (e.g., the use of non-white vertex color values), which may be an import check.

There may be a requirement of a UV Requirement, to include only one UV set in 1:0 (UVs outside 1:0 space is ignored by engine), which may be an import check (but only for checking UV space boundary). This may relate to a situation in which a mesh has UVs defined outside a 0-1 space, which can lead to texturing discrepancies and violates UGC upload requirements. Multiple UV sets are parsed away, but only at import time.

There may be a requirement of fitting to template bodies (Cage UV/geo matches). This may not be an import check and may not be validated at upload. There may be maximum size of 8 by 8 by 8 studs centered on an attachment point. This may not be an import check, because there may be no attachment point at import time.

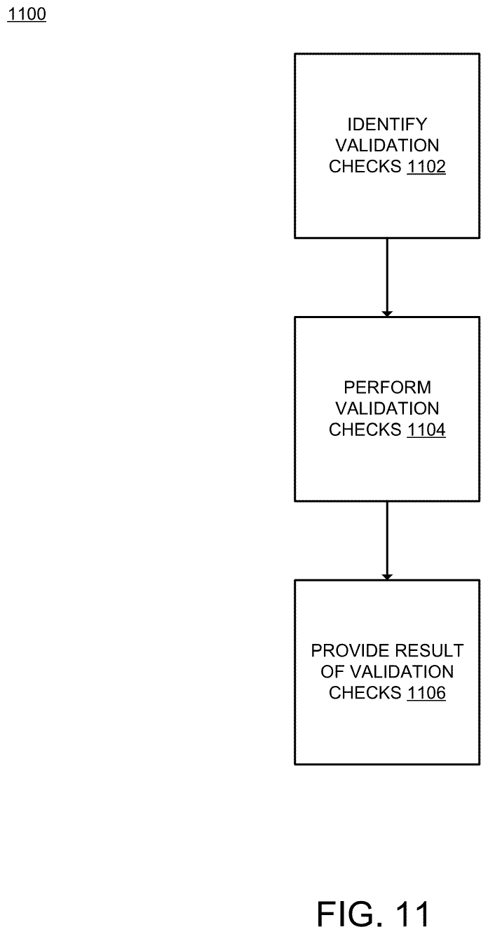

### FIG. 11—Performing Validation Checks

FIG. 11 is a flowchart illustrating a method 1100 of performing validation checks, in accordance with some implementations. Method 1100 may begin at block 1102.

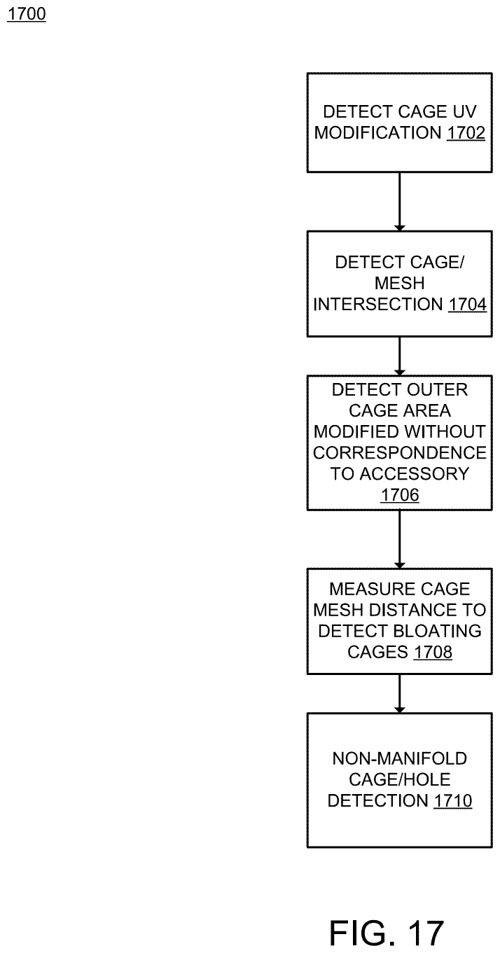

At block 1102, validation checks are identified. Method 1100 may perform a variety of validation checks. For example, checks may relate to inner cage, outer cage, and reference mesh aspects. Checks may also be of different types, as discussed in FIG. 10. For example, checks may be made for errors, warnings, visual quality suggestions, UGC requirements, and so on. As set forth in the discussion of FIG. 10, in some implementations, various particular checks (having various attributes and priorities) may be chosen for performance. For example, the checks may be automatically selected in advance, or may be selected by a user. Other examples of specific checks are set forth and discussed in FIG. 17. Block 1102 may be followed by block 1104.

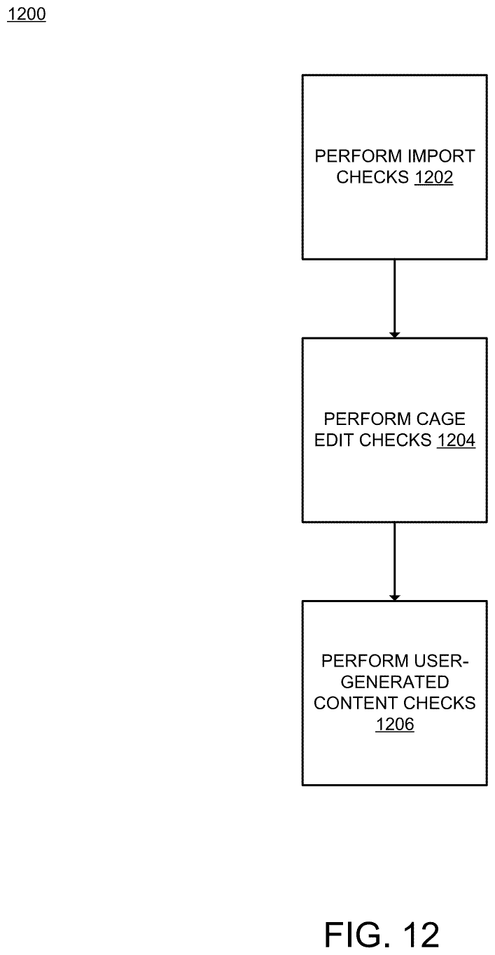

At block 1104, validation checks are performed. Such validation checks may include at least one static validation check. The at least one static validation check may be chosen from a group comprising an import check, a cage edit check, a user-generated content (UGC) check, and combinations thereof. An example of performing such validation checks is presented in FIG. 12.

The static validation checks may also be chosen to identify the presence of at least one from the group comprising: a cage UV modification, a cage and mesh intersection, a modification of an outer cage area that does not correspond to an accessory, a presence of a bloating cage, a presence of non-manifold and hole occurrences, and combinations thereof. An example of performing such validation checks is presented in FIG. 17. Block 1104 may be followed by block 1106.

At block 1106, results of the validation check are provided. Such a result may be informative, or the result may lead to the automatic or manual performance of an action in response to the issue. For example, providing the identified issue may include providing to a user at least one from the group comprising a description of the identified issue, a description of a remedy for the identified issue, a visualization of an area of the clothing item affected by the identified issue, and combinations thereof.

Thus, method 1100 as illustrated in FIG. 11 includes, to validate a clothing item for a three-dimensional (3D) avatar usable in a virtual experience, performing at least one static validation check on the clothing item to validate the clothing item when layered over an underlying surface, based on at least one property of the clothing item from the group comprising: an inner cage of the clothing item, an outer cage of the clothing item, a reference mesh of the clothing item, and combinations thereof. The method also includes, in response to detecting at least one failure result from the at least one static validation check, providing an identified issue based on the at least one static validation check having the at least one failure result.

### FIG. 12—Performing Specific Validation Checks

FIG. 12 is a flowchart illustrating a method 1200 of performing specific validation checks, in accordance with some implementations. Method 1200 may begin at block 1202.

At block 1202, import checks are performed. Such checks may occur when an asset is being imported into a building program. A positive aspect of performing import checks is that performing import checks may illustrate issues as soon as possible so users can fix them in a DCC. Block 1202 may be followed by block 1204.

At block 1204, cage edit checks are performed. Such checks may occur when previewing or editing LC items in a building program. Such checks may illustrate issues again in case artists did not fix issues at the DCC. Cage edit checks may also illustrate new issues that arise based on an artist making edits in a building program. Block 1204 may be followed by block 1206.

At block 1206, user-generated content checks are performed. Such checks may occur as part of the UGC upload process. Such checks may ensure that artists do not unknowingly upload an asset with issues. The check may block bad actors from uploading broken assets (e.g., making an outer cage really large).

Block 1202, block 1204, and block 1206 illustrate three types of validation checks that may be performed. Other types of validation checks are possible. These types of validation checks illustrate ways to identify issues at various stages of a pipeline, providing the ability to identify and resolve issues as soon and as easily as possible. Further, some types of validation checks may be omitted, and other validation checks may be added.

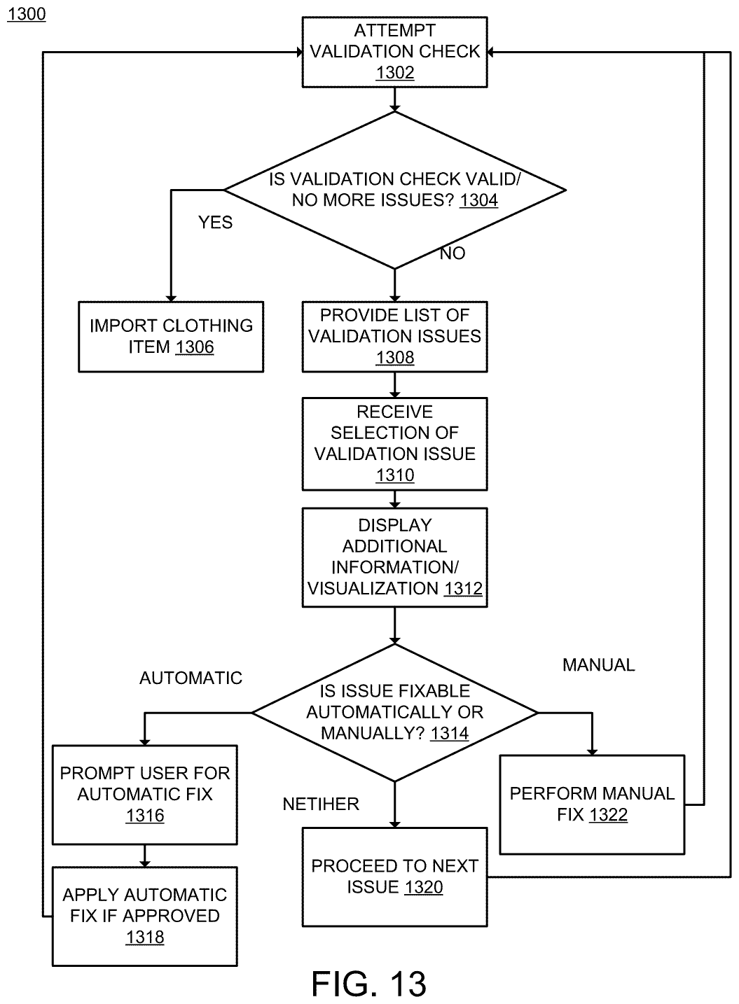

### FIG. 13—Performing Specific Validation Checks

FIG. 13 is a flowchart illustrating a method 1300 including details of performing specific validation checks, in accordance with some implementations. Method 1300 may begin at block 1302. FIG. 13 and FIG. 8 present related subject matter, but FIG. 13 presents the validation checks in a certain way that may help clarify the subject matter presented in both FIG. 8 and FIG. 13.

At block 1302, a validation check may be performed. For example, the validation check may be selected by a user or is automatically selected. Once the validation check is selected, the validation check may be applied appropriately to ascertain whether the asset passes the validation check.

At block 1304, it is determined whether a validation check is valid and/or that there are no more issues to be resolved. If so (i.e., there are no more issues), block 1304 is followed by block 1306. If not (i.e., there are remaining issues), block 1304 is followed by block 1308.

At block 1306, the clothing item being validated is imported. It has been established that no more issues are pending (at block 1304) and hence it is appropriate to import the clothing item.

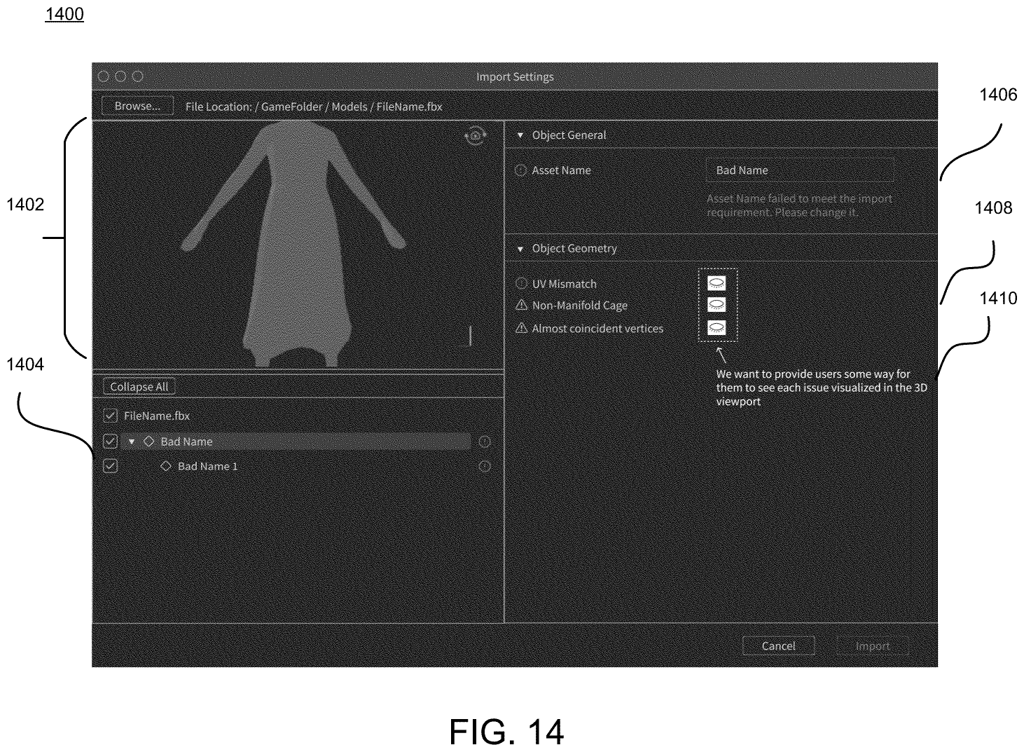

At block 1308, a list of validation issues is provided to a user. While the list of validation issues may be presented solely as text, there may be other aspects to the list, such as a hierarchy of issues or icons to help a user understand the list. Examples of presenting issues are illustrated in FIGS. 14-16 that show examples of user interfaces according to some implementations. Block 1308 may be followed by block 1310.

At block 1310, a selection of a validation issue is received, such as from a user. For example, the user may use a mouse, keyboard, touchscreen, or speech recognition to select a particular issue from a list. Block 1310 may be followed by block 1312.

At block 1312, additional information or a visualization related to the selected issue is displayed. As additional information, part of an interface may provide a user with information. For example, the validation issues may also be presented as various visualizations to help the user understand the nature of the issues.

For example, modified UVs may be visualized by highlighting vertices that were found to have modified UVs. Alternatively, if there is a problem with an outer cage, a visualization may illustrate an outer cage wireframe along with a corresponding mesh and highlight problematic edges/vertices. Such a visualization may vary slightly, depending on the specific issue. For other issues, a visualization may illustrate a cage wireframe without a mesh and highlight problematic vertices. Block 1310 may be followed by block 1312.

At block 1314, it is determined if the selected issue is fixable automatically, manually, or neither. If the issue is fixable automatically, block 1314 is followed by block 1316. If the issue is fixable manually, block 1314 is followed by block 1322. If the issue is fixable in neither way, block 1314 is followed by block 1320.

At block 1316, a user is prompted about an automatic fix. For example, a user may be prompted to authorize the automatic fix or may also be prompted to provide additional information about the automatic fix. For example, there may be parameters for the user to enter when applying the automatic fix. Block 1316 is followed by block 1318.

At block 1318, the automatic fix is applied, if approved. Alternatively, an automatic remedy for the identified issue may be automatically applied (and no approval is sought). Block 1318 may be followed by returning to block 1302 to perform another validation check.

At block 1320, the method proceeds to the next issue. At this point, it has been determined that the issue is not fixable, and the issue may be flagged accordingly. Block 1320 may be followed by returning to block 1302 to perform another validation check.

At block 1322, the manual fix is performed. Such a manual fix may involve interaction with the user to accomplish the fix. For example, if a manual fix is to be performed, a manual remedy for the identified issue may be flagged for performance by a user. Block 1322 may be followed by returning to block 1302 to perform another validation check.

Regardless of whether block 1314 is followed by an automatic fix (at block 1316 and block 1318), a manual fix (at block 1322), or neither (at block 1320, the current issue may be indicated as handled, in that it is resolved in keeping with the user's preference.

Some issues may be errors (which must be resolved for the virtual environment to function properly), while other may be warnings (an issue which is important to fix), visual quality suggestions (which are to be fixed at an artist's discretion), or UGC requirements (which may be necessary to permit an asset to be a part of the layered clothing catalog). Issues may be handled accordingly.

### FIG. 14—Interface to Manage Validation Checks

FIG. 14 is a diagram illustrating an interface 1400 to manage validation checks, in accordance with some implementations.

For example, the interface 1400 includes a silhouette of a dress 1402 (in FIG. 14, the dress 1402 is shown as a silhouette). Beneath dress 1402 is a pane 1404 of the interface 1400 illustrating a hierarchy of error information. For example, pane 1404 illustrates that the object may have a certain error “Bad Name” with a particular Bad Name “Bad Name 1.”

To the right of dress 1402 is a pane 1406. Pane 1406 includes information about “Object General” related issues. Pane 1406 indicates that the type of issue is an “Asset Name” issue. Specifically, the issue is a “Bad Name” issue. Pane 1406 also includes the explanation that “Asset Name failed to meet the import requirement. Please change it.”

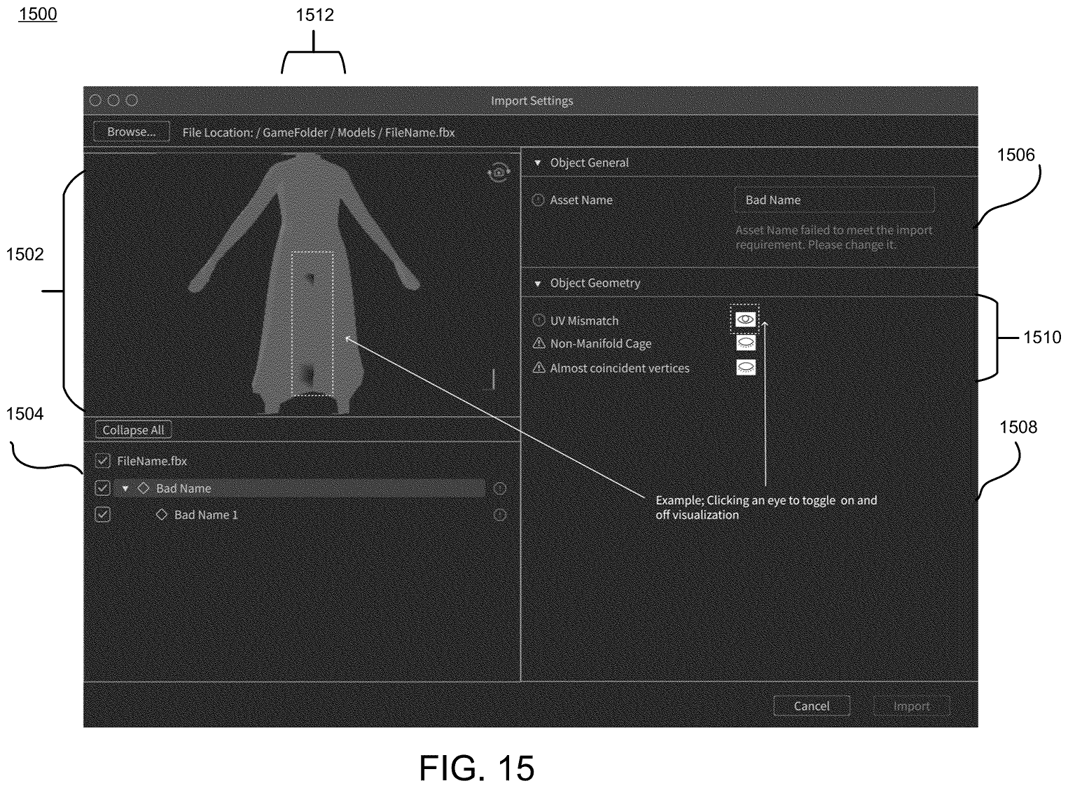

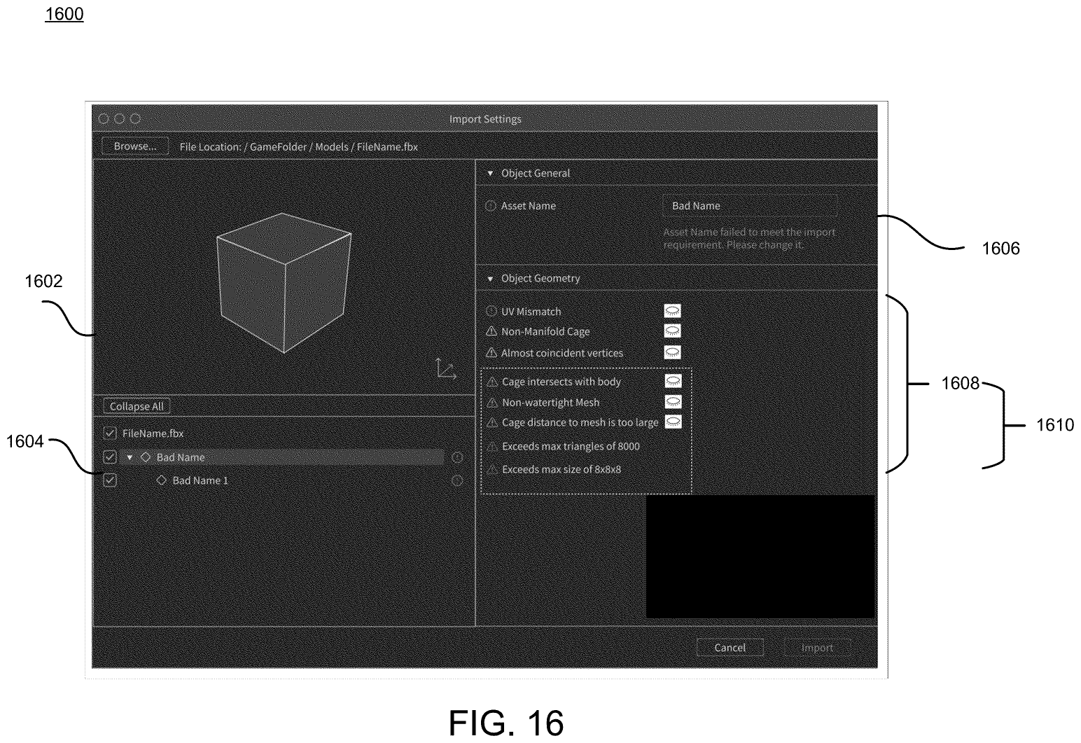

Below pane 1406 is pane 1408. Pane 1408 includes information about “Object Geometry” related issues. For example, there may be error of a UV mismatch, a warning about a non-manifold cage, and a warning about almost coincident vertices. As indicated in pane 1408, there is a label 1410 indicating “We want to provide users some way for them to see each issue visualized in the 3D viewport.” FIG. 15 illustrates an example of such a visualization.

### FIG. 15—Interface to Manage Validation Checks

FIG. 15 is another diagram illustrating an interface 1500 to manage validation checks, in accordance with some implementations. The interface 1500 of FIG. 15 corresponds to the interface 1400 of FIG. 14, albeit with slight modifications. For example, dress 1502 is similar to dress 1402. Pane 1504 is similar to pane 1404. Pane 1506 is similar to pane 1406.

Pane 1508 is similar to pane 1408. However, in pane 1508, there may be a set of checkboxes 1510 in which UV Mismatch is selected. Pane 1508 has a label indicating “Example; Clicking an eye to toggle on and off visualization” as an explanatory label. However, artifacts 1512 are now visible in dress 1502. Dress 1502 presents a visualization including a box (with boundaries indicated by dashed white lines) that illustrate artifacts 1512 on dress 1502 affected by the UV Mismatch issue.

### FIG. 16—Interface to Manage Validation Checks

FIG. 16 is yet another diagram illustrating an interface 1600 to manage validation checks, in accordance with some implementations. For example, the interface 1600 includes a number of panes. In pane 1602, there may be a cube object. In pane 1604, there is a hierarchy of name information, along with “Bad Name” issues.

In pane 1606, there are some “Bad Name” issues that are similar to those presented in FIG. 14 at 1406 and to those presented in FIG. 15 at 1506. With respect to checks 1608, the checks 1608 indicates that we want to do several checks which may raise a large number of issues. Users may be able to ignore certain categories of issues if the users deem it not applicable to them.

Specifically, checks 1608 includes an error (UV Mismatch) and warnings (Non-Manifold Cage and Almost Coincident Vertices). Unless errors are fixed, a virtual environment does not work at all. Unless warnings are fixed, there may be serious problems in the virtual environment. Thus, errors and warnings are best not ignored. However, there may be visual quality issues and UGC issues as checks 1610. The visual quality issues (Cage intersects with body, Non-watertight Mesh, and Cage distance to mesh is too large) may be ignored by artists as they see fit. UGC issues (Exceeds max triangles of 8000, Exceeds max size of 8×8×8) may only apply if an asset is being uploaded into a catalog.

### FIG. 17—Details of Performing Specific Validation Checks

FIG. 17 is a flowchart illustrating a method 1700 including details of performing specific validation checks, in accordance with some implementations. Method 1700 may begin at block 1702.

At block 1702, cage UV modification is detected. Such detection may include creating a spatial hash map for a UV map of the inner cage of the clothing item based on values for vertices of the UV map of the inner cage of the clothing item, and detecting collisions of the UV map of the outer cage of the clothing item with corresponding vertices of the UV map of the inner cage of the clothing item based on the spatial hash map.

An inner/outer cage UV map may not be modified from an original template through the entire creation process. However, due to the missing correspondence between the created cage and the template (e.g., vertex position and index changed), it may not be possible to directly compare if the cage UVs are the same as the template.

A solution is to compare the inner cage UV map with the outer cage UV map. If they are the same, then it can be assumed that the UV map has not been modified. The foregoing may be based on an assumption that the UV map is not changed to the same value in the inner and outer cage at the same time if the UV map is modified by accident.

To compare the inner and outer cage UV map, a spatial hash map may be created for the inner cage UV map based on the value for each vertex, and then the spatial hash map may be used as a key to detect collision of the outer cage UV for each vertex. If the UV map has not been modified, the total number of unique hashes of the inner/outer cage UV may be the same, and the hash values of the outer cage UV may be found as collision in the spatial hash map of the inner cage UV. Block 1702 may be followed by block 1704.

At block 1704, cage/mesh intersection is detected. Such identifying may include finding correspondences between vertices in the inner cage of the clothing item and vertices of the outer cage of the clothing item and performing raycasting between the corresponding vertices to identify intersecting vertices that indicate the cage and mesh intersection.

To make layered clothing work in keeping with user instructions, the inner cage may be inside the reference mesh and the outer cage may be outside, and no intersection may be expected between the cage and mesh. Detecting complex mesh intersections is a non-trivial problem because of the mesh topology and granularity.

A validation check of various implementations detects vertex-based cage mesh intersection problems. Because a correctly designed inner and outer cage may share the exact same topology and UV map (guaranteed by other checks performed by the quality checker tool), UV may be used to find correspondences between the vertices in inner and outer cages, which may assist in detecting an intersection. Once there are correspondences between vertices, the validation check can cast rays from each outer cage vertex to its corresponding inner cage vertex.

If a ray hits the reference mesh between the inner and outer cage vertices, for this particular area, then there are no intersections between cage and mesh. If the hit is inside the inner cage, then there are intersections between the inner cage and reference mesh. Analogously, if the hit is outside the outer cage, then the intersections happen between the outer cage and reference mesh. Block 1704 may be followed by block 1706.

At block 1706, it is detected that an outer cage that does not correspond to an accessory has been modified. Such detecting may include finding correspondences between vertices in the inner cage of the clothing item and vertices in the outer cage of the clothing item and analyzing line segments that connect the corresponding vertices.

As cages are designed on a full body, the outer cage can be modified accidentally when no reference mesh exists. For example, there may be no modifications for the legs on the outer cage if the layered clothing is a shirt.

A validation check of various implementations detect such a problem using the inner and outer cage vertices correspondence in a manner similar to the cage and mesh intersection validation check. If the corresponding vertices on inner and outer cages share the same position, then there is no modification.

If not sharing the same position, then a check is performed to determine if the line segment between the two vertices intersects with the reference mesh or not. If the line segment does intersect, then the outer cage is modified properly for the accessory. However, if the line segment does not intersect, then a check is performed to determine if there is irrelevant outer cage modification. To perform this checking, a distance between the outer cage vertex and its closest vertex on the mesh is computed. If the distance is larger than the line segment plus a fixed distance (to exclude the case of concave meshes), then there is an irrelevant modification. Block 1706 may be followed by block 1708.

At block 1708, cage mesh distance is measured to detect (and prevent) bloating cages. Such bloating cages may occur in certain area(s). Identifying such bloating may include measuring cage mesh distances as distances between vertices of the reference mesh of the clothing item and corresponding vertices of the outer cage of the clothing item and building a Gaussian distribution based on the cage mesh distances, wherein if the cage mesh distances for predetermined vertices exceed a predetermined number of standard deviations of the Gaussian distribution, the predetermined vertices are identified as part of the bloating cage.

A cage mesh distance may be defined in some implementations as the distance between the reference mesh and the outer cage. As the distance is not uniformly distributed, the distance is measured for each vertex on the outer cage. The line segment between the corresponding vertices from the inner and outer cages is used.

If the line segment hits the reference mesh, then the distance between the hit to the outer cage vertex is measured and is used as the cage mesh distance. To identify the bloating cage problem, the cage mesh distances are measured for the vertices on the outer cage and are used to build a Gaussian distribution. If the distances for certain vertices are larger than three standard deviations, for example, then those vertices on the outer cage are considered as a bloating area. Block 1708 may be followed by block 1710.

At block 1710, non-manifold cage/hole detection may be performed. The detection may include detecting the non-manifold and/or hole occurrences using edge loops using half angle and half edge information in at least one from the group comprising the inner cage of the clothing item, the outer cage of the clothing item, and combinations thereof. A validation check of some implementations uses edge loops to detect non-manifold and potential holes in a cage.

The foregoing are just a few examples of validation checks that may be performed by the quality checker tool. While block 1702, block 1704, block 1706, block 1708, and block 1710 are presented as having a certain order, other orderings are possible. Some of the checks set forth with respect to FIG. 17 may be omitted, and additional checks performed in different ways may also be possible.

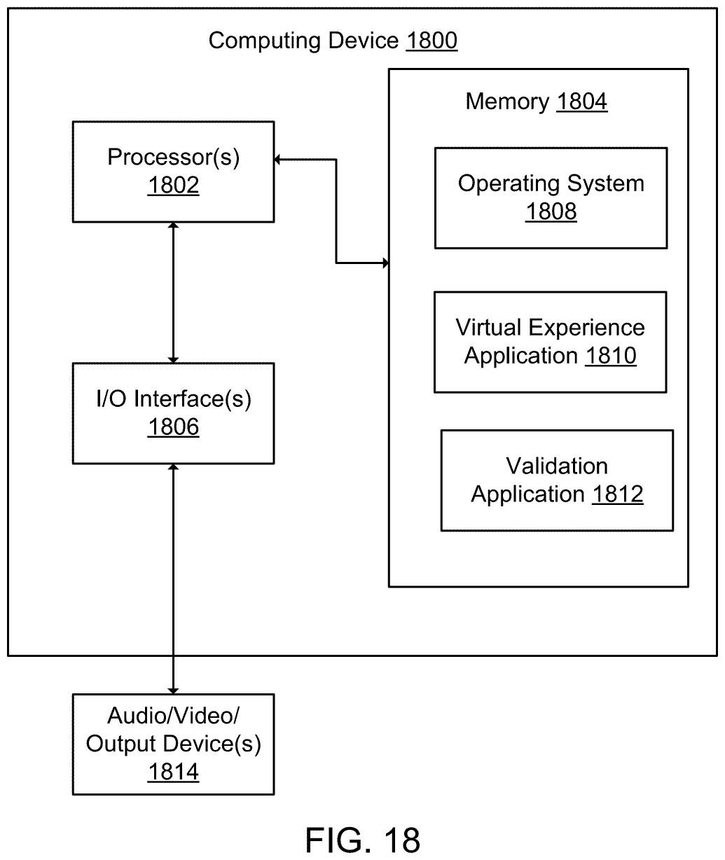

### FIG. 18—Example Computing Device

FIG. 18 is a block diagram illustrating an example computing device, in accordance with some implementations.

FIG. 18 is a block diagram that illustrates an example computing device 1800 which may be used to implement one or more features described herein, in accordance with some implementations. In one example, computing device 1800 may be used to implement a computer device (e.g., 102 and/or 110 of FIG. 1), and perform appropriate method implementations described herein. Computing device 1800 can be any suitable computer system, server, or other electronic or hardware device. For example, the computing device 1800 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, computing device 1800 includes a processor 1802, a memory 1804, input/output (I/O) interface(s) 1806, and audio/video input/output devices 1814.

Processor 1802 can be one or more processors and/or processing circuits to execute program code and control basic operations of the computing device 1800. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1804 is typically provided in computing device 1800 for access by the processor 1802, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1802 and/or integrated therewith. Memory 1804 can store software operating on the computing device 1800 by the processor 1802, including an operating system 1808, a virtual experience application 1810, a validation application 1812, and other applications (not shown). In some implementations, virtual experience application 1810 and/or validation application 1812 can include instructions that enable processor 1802 to perform the functions (or control the functions of) described herein, e.g., some or all of the methods described with respect to FIGS. 8-9, 11-13, and 17.

For example, virtual experience application 1810 can include a validation application 1812, which as described herein can provide validation checks for Layered Clothing (LC) assets within an online virtual experience server (e.g., 102). Elements of software in memory 1804 can alternatively be stored on any other suitable storage location or computer-readable medium. In addition, memory 1804 (and/or other connected storage device(s)) can store instructions and data used in the features described herein. Memory 1804 and any other type of storage (magnetic disk, optical disk, magnetic tape, or other tangible media) can be considered “storage” or “storage devices.”

I/O interface(s) 1806 can provide functions to enable interfacing the computing device 1800 with other systems and devices. For example, network communication devices, storage devices (e.g., memory and/or data store 120), and input/output devices can communicate via I/O interface(s) 1806. In some implementations, the I/O interface(s) 1806 can connect to interface devices including input devices (keyboard, pointing device, touchscreen, microphone, camera, scanner, etc.) and/or output devices (display device, speaker devices, printer, motor, etc.).

The audio/video input/output devices 1814 can include a user input device (e.g., a mouse, etc.) that can be used to receive user input, a display device (e.g., screen, monitor, etc.) and/or a combined input and display device, that can be used to provide graphical and/or visual output.

For case of illustration, FIG. 18 shows one block for each of processor 1802, memory 1804, I/O interface(s) 1806, and software blocks of operating system 1808, virtual experience application 1810, and validation application 1812. These blocks may represent one or more processors or processing circuitries, operating systems, memories, I/O interfaces, applications, and/or software engines. In other implementations, computing device 1800 may not have all of the components shown and/or may have other elements including other types of elements instead of, or in addition to, those shown herein. While the online virtual experience server 102 is described as performing operations as described in some implementations herein, any suitable component or combination of components of online virtual experience server 102 or similar system, or any suitable processor or processors associated with such a system, may perform the operations described.

A user device can also implement and/or be used with features described herein. Example user devices can be computer devices including some similar components as the computing device 1800, e.g., processor(s) 1802, memory 1804, and I/O interface(s) 1806. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 1814, for example, can be connected to (or included in) the computing device 1800 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., methods 800, 900, 1100, 1200, 1300, and 1700) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method to validate a clothing item for a three-dimensional (3D) avatar usable in a virtual experience, the computer-implemented method comprising:
performing at least one static validation check on the clothing item to validate the clothing item when layered over an underlying surface, based on at least one property of the clothing item from the group comprising: an inner cage of the clothing item, an outer cage of the clothing item, a reference mesh of the clothing item, and combinations thereof; and
in response to detecting at least one failure result from the at least one static validation check, providing an identified issue based on the at least one static validation check having the at least one failure result.

2. The computer-implemented method of claim 1, wherein providing the identified issue comprises providing to a user at least one from the group comprising: a description of the identified issue, a description of a remedy for the identified issue, a visualization of an area of the clothing item affected by the identified issue, and combinations thereof.

3. The computer-implemented method of claim 1, further comprising automatically performing an automatic remedy for the identified issue.

4. The computer-implemented method of claim 1, further comprising flagging a manual remedy for the identified issue for performance by a user.

5. The computer-implemented method of claim 1, wherein performing the at least one static validation check comprises performing at least one from the group comprising: an import check, a cage edit check, a user-generated content (UGC) check, and combinations thereof.

6. The computer-implemented method of claim 1, wherein performing the at least one static validation check comprises identifying at least one from the group comprising: a cage UV modification, a cage and mesh intersection, a modification of an outer cage area that does not correspond to an accessory, a presence of a bloating cage, a presence of non-manifold and hole occurrences, and combinations thereof.

7. The computer-implemented method of claim 6, wherein identifying the cage UV modification comprises:
creating a spatial hash map for a UV map of the inner cage of the clothing item based on values for vertices of the UV map of the inner cage of the clothing item; and
detecting collisions of the UV map of the outer cage of the clothing item with corresponding vertices of the UV map of the inner cage of the clothing item based on the spatial hash map.

8. The computer-implemented method of claim 6, wherein identifying the cage and mesh intersection comprises:
finding correspondences between vertices in the inner cage of the clothing item and vertices of the outer cage of the clothing item; and
performing raycasting between the corresponding vertices to identify intersecting vertices that indicate the cage and mesh intersection.

9. The computer-implemented method of claim 6, wherein identifying the modification of the outer cage area that does not correspond to an accessory comprises:
finding correspondences between vertices in the inner cage of the clothing item and vertices in the outer cage of the clothing item; and
analyzing line segments that connect the corresponding vertices.

10. The computer-implemented method of claim 6, wherein identifying the presence of the bloating cage comprises:
measuring cage mesh distances as distances between vertices of the reference mesh of the clothing item and corresponding vertices of the outer cage of the clothing item; and
building a Gaussian distribution based on the cage mesh distances, wherein if the cage mesh distances for predetermined vertices exceed a predetermined number of standard deviations of the Gaussian distribution, the predetermined vertices are identified as part of the bloating cage.

11. The computer-implemented method of claim 6, wherein identifying the presence of the non-manifold and hole occurrences comprises detecting the non-manifold and hole occurrences using edge loops using half angle and half edge information in at least one from the group comprising: the inner cage of the clothing item, the outer cage of the clothing item, and combinations thereof.

12. The computer-implemented method of claim 1, further comprising categorizing respective static validation checks of the at least one static validation check as one of an error, a warning, a visual quality suggestion check, or a user-generated content (UGC) check.

13. The computer-implemented method of claim 1, wherein in response to at least one result of the at least one static validation check indicating that the clothing item satisfies a threshold number of static validation checks of the at least one static validation check, importing the clothing item into the virtual experience, wherein after the importing, the clothing item is available to be worn by an avatar that participates in the virtual experience.

14. A non-transitory computer-readable medium with instructions stored thereon that, responsive to execution by a processing device, causes the processing device to perform operations comprising:
performing at least one static validation check on a clothing item to validate the clothing item when layered over an underlying surface, based on at least one property of the clothing item from the group comprising: an inner cage of the clothing item, an outer cage of the clothing item, a reference mesh of the clothing item, and combinations thereof; and
in response to detecting at least one failure result from the at least one static validation check, providing an identified issue based on the at least one static validation check having the at least one failure result.

15. The non-transitory computer-readable medium of claim 14, wherein providing the identified issue comprises providing to a user at least one from the group comprising: a description of the identified issue, a description of a remedy for the identified issue, a visualization of an area of the clothing item affected by the identified issue, and combinations thereof.

16. The non-transitory computer-readable medium of claim 14, wherein performing the at least one static validation check comprises performing at least one from the group comprising: an import check, a cage edit check, a user-generated content (UGC) check, and combinations thereof.

17. The non-transitory computer-readable medium of claim 14, wherein performing the at least one static validation check comprises identifying at least one from the group comprising: a cage UV modification, a cage and mesh intersection, a modification of an outer cage area that does not correspond to an accessory, a presence of a bloating cage, a presence of non-manifold and hole occurrences, and combinations thereof.

18. A system, comprising:
a memory with instructions stored thereon; and
a processing device, coupled to the memory, the processing device configured to access the memory and execute the instructions, wherein the instructions cause the processing device to perform operations comprising:
performing at least one static validation check on a clothing item to validate the clothing item when layered over an underlying surface, based on at least one property of the clothing item from the group comprising: an inner cage of the clothing item, an outer cage of the clothing item, a reference mesh of the clothing item, and combinations thereof; and
in response to detecting at least one failure result from the at least one static validation check, providing an identified issue based on the at least one static validation check having the at least one failure result.

19. The system of claim 18, wherein performing the at least one static validation check comprises performing at least one from the group comprising: an import check, a cage edit check, a user-generated content (UGC) check, and combinations thereof.

20. The system of claim 18, wherein performing the at least one static validation check comprises identifying at least one from the group comprising: a cage UV modification, a cage and mesh intersection, a modification of an outer cage area that does not correspond to an accessory, a presence of a bloating cage, a presence of non-manifold and hole occurrences, and combinations thereof.
